(19) United States
(12) Patent Application Publication
(10) Pub. No.: US 2011/0320509 A1
(43) Pub. Date: Dec. 29, 2011

(54) MANAGING THE SITE WHERE DATA IS STORED IN A DISTRIBUTED STORAGE SYSTEM

(75) Inventor: Fabrice Baranski, Rennes (FR)

(73) Assignee: France Telecom, Paris (FR)

(21) Appl. No.: 13/167,031

(22) Filed: Jun. 23, 2011

(30) Foreign Application Priority Data
Jun. 29, 2010 (FR) 10 55257

(51) Int. Cl. G06F 17/30

(52) U.S. Cl. 707/827; 707/E17.032

(57) ABSTRACT

A management method for managing the site is provided where data is stored in a distributed storage system including a plurality of devices connected together by means of a network, the devices having respective data storage sites in which a user may store data, wherein the site where data is stored in the system is selected as a function of information associated with the user of the system.

### CROSS-REFERENCE TO RELATED PATENT APPLICATION

This application claims the benefit of French Patent Application No. 10 55257, filed on Jun. 29, 2010, in the French Institute of Industrial Property, the entire contents of which is incorporated herein by reference.

### FIELD OF THE INVENTION

The invention relates to a method of managing the site where data is stored in a distributed storage system. A distributed storage system comprises a plurality of data processor devices that are connected to one another and that together form a unified storage space.

### BACKGROUND

Storage devices are data processor devices including at least one processor and at least one memory for storing digital data referred to below by the term “digital content”. A storage device may for example be a computer, a radiotelephone, an MP3 type reader/writer, or a hard disk of the network attached storage (NAS) type, etc.

The digital content may be arbitrary. It may be musical content, a computer program, etc.

Nowadays, a user has several data processor devices for storing content. A user may have fixed electronic devices such as a personal computer or a NAS type hard disk, etc. A user may also have mobile electronic devices such as a radiotelephone, a camera, etc. Finally, a user may have access to electronic devices, usually servers, that provide on-line storage spaces (flickR, box.net, . . . ) that are accessible via a network, e.g. the Internet.

These various devices have hardware and software resources including at least one processor and at least one storage space enabling content to be manipulated locally, where manipulation includes reading and/or writing data.

A distributed storage system has devices such as those described above that are connected to one another via a network in order to form a uniform storage space. By way of example, this space constitutes a home network. In other words, a user seeking to write or read content to or from a distributed storage system can do so using a device selected from amongst the devices of the distributed storage system.

For this purpose, a management module has the function of managing data manipulation in the unified storage space. To do this, the module stores a list of contents, the storage site of each content, i.e. the storage means on which the content is stored, and the location of the content within the distributed storage system, i.e. the memory. By way of example, if the storage means is a hard disk, the “location” is a track on the hard disk associated with one or more disk sectors.

The inventors have found that data is stored either randomly within the system, or else as a function of criteria that are associated with the nature of the content.

However, it can happen that a user disconnects a device from the distributed storage system in order to manipulate the data in a “not connected” mode. The device is no longer connected to the network that forms the distributed storage system. In such a configuration, and assuming that the module is situated other than in the disconnected device, the disconnected device is no longer able to access the module and is thus no longer able to access the data in the distributed storage system.

The invention seeks to improve that situation.

### SUMMARY

To this end, the invention provides a management method for managing the site where data is stored in a distributed storage system including a plurality of devices connected together by means of a network, the devices having respective data storage sites in which a user may store data, wherein the site where data is stored in the system is selected as a function of information associated with the user of the system.

Thus, according to the invention, the data is transferred from a source device to a destination device if the data in question is stored on a device that is different from the selected device.

According to the invention, information associated with the user is recovered and is used as a basis for selecting the site where data is to be stored from amongst the multiple storage sites constituting the distributed storage system. Thus, as explained below, if by way of example the information is information associated with the user being active on a device of the system, then the selected device is the device that is being used by the user, for example. Selecting the device that is in use as the device for storing data thus reduces the time required to access the data, since data access takes place directly and locally in the storage site of the device itself and not in a storage site external to the device. The invention also makes it possible for the user to disconnect the device in question from the network of the distributed storage system and to manipulate the data after disconnection. Thus, in the invention, when the storage site is selected and the data in question is stored on a device other than the selected device, the data is transferred from said other device of the system to the selected device.

As mentioned above, the information may be information relating to the user's activity on a device.

Activity on a device may be deduced by a microprocessor installed in the device in question. For example, receiving a command to execute a particular program may suffice to declare that the user is using the device having the microprocessor.

In this example, the information corresponds to a state of the user of the system as defined relative to an interpersonal communications tool. As explained below, this state may be real or assumed.

Above, it is stated that the data may be transferred from a source device to a destination device. Data transfer may take various forms, each associated with a respective advantage.

In a first form, after transfer, the data stored in the source device is erased. This characteristic has the advantage of avoiding redundancy and also of optimizing the occupancy of memory in the distributed storage system.

In a distributed data storage system, a management module serves to manage the site where data is stored in the distributed storage system. In this configuration, and in a second transfer form, after data has been transferred from the source storage site to a destination storage site, the data stored in the source device is conserved, and if a transfer from said designation storage site to said source device relates to the same data, then said transfer comprises a step of updating the new storage site. The advantage associated with this characteristic is that content that has been transferred from a first device to a second device and that is to be transferred once more from the second device to the first device does not need to be transferred again. Only the storage site needs to be updated by the manager. In the example described below it can be seen that the management module is in charge of this updating.

In a hardware aspect, the invention provides a distributed storage system including a plurality of devices, each having respective storage means in which a user can store data, the devices being connected to one another via a network, wherein the system includes a module suitable for selecting a data storage site within the system as a function of information associated with the user of the system.

In another a hardware aspect, the invention provides a module suitable for managing the site where data is stored in a distributed storage system including a plurality of devices connected to one another via a network, the devices including respective data storage sites in which a user can store data. This module includes selector means suitable for selecting a data storage site within the system as a function of information associated with the user of the system.

Finally, the invention also provides a computer program including instructions for implementing the above-mentioned method on the above-mentioned module when the program is executed by a processor.

The invention can be better understood on reading the following description given purely by way of example and made with reference to the accompanying drawings.

### BRIEF DESCRIPTION OF THE DRAWINGS

FIGS. 1 and 2 are diagrammatic views of a distributed storage system at different instants.

FIGS. 3 and 4 are views showing data exchanges between devices of the distributed storage system, illustrating a first implementation of the invention.

FIGS. 5 and 6 are views of data exchanges between devices of the distributed storage system illustrating a second implementation of the invention.

### DETAILED DESCRIPTION

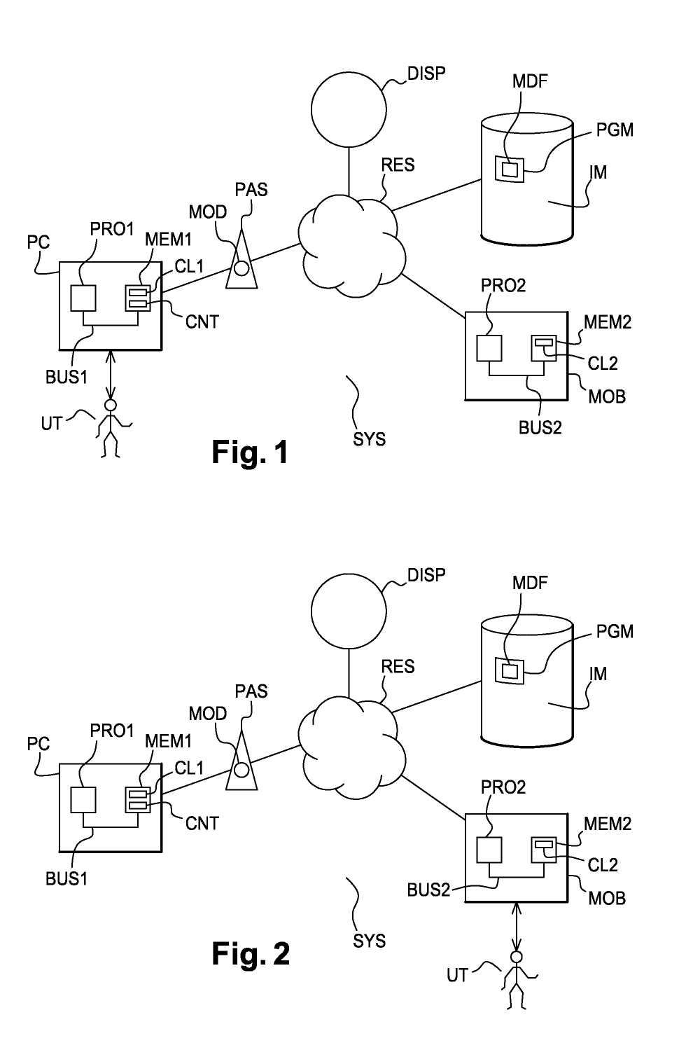

FIG. 1 shows a distributed storage system SYS comprising a plurality of devices on which contents can be manipulated. It is also specified that manipulation includes both writing and reading data in a memory, and that writing includes creating data and modifying data.

Each device of said system comprises at least one processor, and each processor is associated with at least one memory for storing data. The memory in question may be situated within the device, or it may be situated outside it and thus be accessible via a communications network such as a telecommunications network. In this example, each device has a memory. It should be observed that the memory may be of any type.

In this example, in order to simplify the description of the invention, the distributed storage system SYS comprises only two storage devices, a first device PC represented by means of a personal computer, and a second device MOB represented by means of a mobile telephone.

In this example, the computer PC comprises a first processor PRO1, connected to a first memory MEM1 by means of a first bus BUS1. In this example, the telephone MOB comprises a second processor PRO2, connected to a second memory MEM2, via a second bus BUS2.

Each device is powered by an energy source, e.g. by a source of electrical energy.

In this example, the devices are connected together by means of a network RES so as to form the distributed storage system.

It should be observed that the example has a local network, however the devices of the storage system may be situated far apart from one another and accessible via a suitable network, e.g. the Internet.

The devices store data of all kinds. For example, in this example it is assumed that the PC stores content CNT in the first memory MEM1.

In this example, a management module MOD serves to manage the sites where data is stored. To do this, the module stores a list of contents together with their storage site(s) and also the locations of the contents in the devices of the distributed storage system. For example, in this illustration, the module stores an identifier of the content CNT, the storage site, namely the computer PC, and the location of the content in memory. In this way, on receiving a request for access to one or more contents, the module knows the location corresponding to the content(s) in the system and can therefore deliver the location(s) in question.

The storage site of the module MOD may be anywhere. In this example, in order to provide good data availability, the module is stored on the device having the longest mean time between failures (MTBF). By way of example, the module is on a gateway that is interposed between the computer PC and the network RES.

According to the invention, the site where data is stored is a function of information associated with the user. In this implementation, this information is a user status relative to a respective device of the system SYS. By means of the invention, the storage sites of all or some of the contents stored in the distributed storage system may vary over time as a function of the status of the user. Examples of user statuses are described below.

The real or assumed status is associated with the activity of the user. This status may be the status used in an interpersonal communications system. The term “assumed” is used of a status to designate a status that is declared by the user but that does not necessarily match reality.

In this example, and for this purpose, the system further comprises:
an instant messaging server IM having programs PGM enabling various devices of the network to communicate with one another, namely the computer PC, the telephone MOB, and other devices DISP connected to the network RES; and
client programs referred to as first client and second client that are installed respectively in the computer PC and the mobile telephone MOB, having a graphics interface (not shown) including in particular a module for taking account of the status of the user in which the client program is located.

The server IM also includes means MDF for receiving changes of status and means for transmitting the new status of a user to the client programs needing this information.

There is no need to go into the details of how instant messaging operates since they are of no relevance for illustrating the invention. Furthermore, any other interpersonal communications tool could be used instead of instant messaging.

In this example, the computer PC and the mobile telephone MOB are likely to be used by a user UT.

In this example, the module MOD includes means for receiving user statuses and for updating the statuses received from the server IM.

In this example, it is assumed that the user may have several different states relative to the interpersonal communications tool. In this example, these statuses are:
“on line” meaning that the user is using the interpersonal communications tool; and
“off line” meaning that the user is not using the interpersonal communications tool.

The invention is not limited to these two statuses, but naturally extends to other statuses.

According to the invention, each status corresponds to a content storage site. The user UT previously constructs a correspondence table, e.g. the following table, associating the action to be performed for any given state. The table is as follows:

| | User status |
|---|---|
| Terminal | On line |
| PC | CNT on PC |
| MOB | CNT on MOB |

This table means that the user UT desires that the content CNT should be stored on and accessible to the computer PC if the status is “on line” relative to the computer PC. Similarly, the user UT desires that the content should be stored on the mobile telephone MOB if the status is “on line” relative to the mobile telephone. The description is limited to the above-described table; nevertheless, the number of statuses and the number of actions that can be provided as a function of status may naturally be greater.

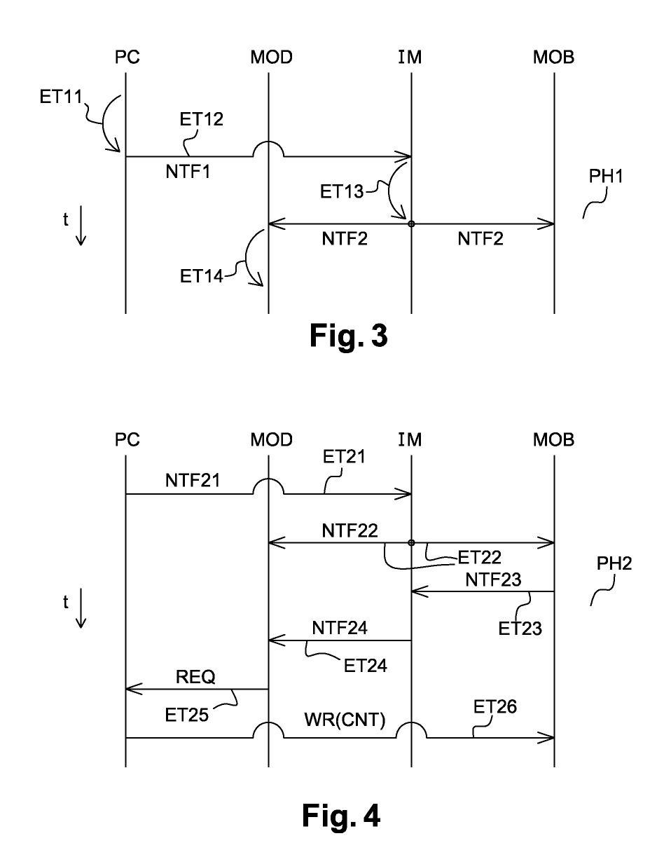

The steps of a first implementation of the invention are described below with reference to FIGS. 1, 2, 3, and 4.

During a first phase PH1, reference is made to FIG. 1 which is a view of the system at an instant “t”. It is assumed that the content CNT is stored on the computer PC at the instant “t”.

This first phase PH1 comprises the following steps referenced ET1n (where n=1 to 4):

During a first step ET11, the user UT switches on the computer PC and executes the first client program CL1. The status of the user UT relative to the computer PC is “on line”.

During a second step ET12, the first client CL1 included in the computer PC uses first notification means NTF1 to notify the “on line” status to the server IM.

During a third step ET13, the server receives the first notification NTF1 and in return uses a second notification NTF2 to send the “on line” status to devices that need to know the status, i.e. in this example the mobile telephone MOB, the module MOD, and any other devices DISP constituting contacts of the user UT.

During a fourth step ET14, the module MOD receives the user's “on line” status relative to the computer PC. In this example, the module MOD stores the above-described table. In this context, it can verify where the content CNT ought to be stored as a function of the received status. The module observes that the content CNT ought to be stored on the computer in this configuration, and that the content is already stored on the computer PC. Under such circumstances, the module requires no movement of content from one device to another.

Thereafter, during a second phase PH2, the user's status changes. The user's status relative to the computer goes from the “on line” status to the “off line” status, whereas said status relative to the mobile telephone goes from the “off line” status to the “on line” status. FIGS. 2 and 4 show this second phase.

FIG. 2 is the same as FIG. 1 except that this figure is a diagrammatic view of the system at a later instant “t+T1”. At this instant “t+T1”, the user has switched off the computer and is using the mobile telephone MOB.

The steps ET2n (for n=1 to 6) that follow relate to the second phase PH2.

During a first step ET21, the new “off line” status relative to the computer is notified to the server IM by means of first notification means NTF21.

During a second step ET22, the server uses second notification means NTF22 to notify the new status. In this example, this notification is sent at least to the module MOD.

In this example, and at this stage, the status relative to the mobile telephone MOB is modified. By way of example, the status is modified because the user has executed the second client CL2 present on the mobile telephone in order to communicate by means of the telephone.

During a third step ET23, the second client CL2 uses a third notification NT23 to notify the server IM of the new “on line” status relative to the mobile telephone.

During a fourth step ET24, the server uses a fourth notification NTF24 to notify the new “on line” status relative to the mobile telephone MOB. In this example, the server notifies this new status at least to the module MOD.

On receiving it, the module MOD consults the above-described table. The table indicates that when the status is “on line” relative to the mobile telephone MOB, then content should be stored on the telephone. However, at this stage, the content CNT is stored on the computer PC (see 1^{st} phase PH1).

The module thus sends a request REQ to the computer PC during a fifth step ET25 to transfer the content from the computer to the mobile telephone MOB.

During a sixth step ET26, the computer sends to the telephone a write command WR(CNT) to write the content CNT in the second memory MEM2 present in the mobile telephone MOB.

At this stage of the method, the content CNT is stored in the second memory MEM2 of the mobile telephone MOB.

During an optional seventh step (not shown), the user accesses the content CNT.

At this stage of the method, and if so desired, the user may disconnect the mobile telephone from the network RES and manipulate the content in a disconnected mode.

A second implementation is described below with reference to FIGS. 1, 2, 5, and 6. In this second implementation, the module MOD is suitable for intercepting presence state notifications. Interception serves to avoid waiting for a notification coming from the server IM and thus makes it possible to anticipate a transfer of content.

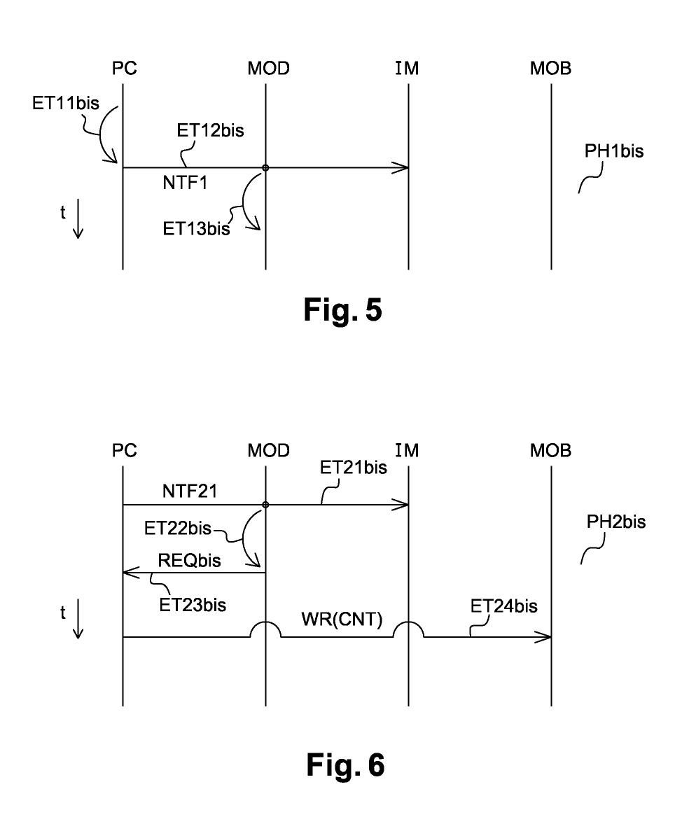

The phases 1 and 2 as described above are modified as follows; the first phase of the second implementation being described with reference to FIG. 5.

This first phase PH1bis of the second implementation comprises the following steps ET1nbis (for n=1 to 3):

During a first step ET11bis, the user UT switches on the computer PC. The status of the user UT relative to the computer PC is “on line”.

During a second step ET12bis, the first client CL1 included in the computer PC uses a first notification NTF1 to notify the “on line” status to the server IM.

During a third step ET13bis, the module MOD intercepts the “on line” status of the user relative to the computer PC. In this example, the module MOD stores the above-described table. In this context, it can verify where the content CNT ought to be stored as a function of the received status. The module observes that in this configuration, the content CNT is to be stored on the computer, and that the content is already stored on the computer PC. The module therefore does not need to require any movement of content from one device to another.

The second phase PH2bis of the second implementation is described with reference to FIG. 6. This second phase PH2bis comprises the steps ET2n (for n=1 to 4).

During a first step ET21bis, the new “off line” status relative to the computer is notified by means of a first notification NTF21 to the server IM.

During a second step ET22bis, the module intercepts the first notification NTF21. On receiving it, the module MOD consults the above-described table. The table indicates that the status is “on line” relative to the mobile telephone MOB, so the content should be stored on the telephone. However, at this stage, the content CNT is stored on the computer PC (see 1^{st} phase PH1bis).

The module MOD thus uses a request REQbis sent to the PC during a third step ET23bis to request the transfer of the content from the computer to the mobile telephone MOB.

During a fourth step ET24bis, the computer sends a command to the telephone to write the content CNT into the second memory present in the telephone.

At this stage of the method, the content CNT is stored in the second memory.

In an optional fifth step ET25bis, the user accesses the content.

It should be observed that both of the above-described implementations can be used in isolation or in combination.

In the above implementation, the content CNT is transferred from one device to another device of the distributed storage system SYS. Consider a source device storing content CNT and a destination device for the content. In the present description, the transfer may have various forms associated with respective advantages.

A first form consists in transferring content by copying the content into a target device and subsequently erasing the content from the source device. This first form of transfer has the advantage of avoiding redundancy for the same content in a distributed storage system.

A second form consists in not deleting from the source device the content that has been copied into the target device. This redundancy ensures that the content is backed up in the event of the content being lost from the target device or from the source device. This second form also presents another advantage if the content is to be transferred in the opposite direction, i.e. from the target device to the source device. In this configuration, and preferably when the content has not been modified, a transfer consists in updating the table stored in the module MOD in order to indicate that the content is now accessible from the source device. This second form is advantageous since it requires very little bandwidth, involving no more than the destination device sending a command to the module MOD to update the table.

This second form requires adjusting in the event of the content being modified between the moment it was received from the designation device and returned to the source device. A content synchronization mechanism, known to the person skilled in the art, may be implemented in order to ensure synchronization between the content stored on the source device and on the destination device.

In the above implementations, the transfer involved content. The content may be arbitrary. For example, the content may be a file or a directory of a tree structure. For example, the user may create a directory of personal files and directories that are personal and a directory of professional files and directories that are professional. Thus, the transfer may relate to one or the other of those directories as a function of the user's status.

What is claimed is:

1. A management method for managing the site where data is stored in a distributed storage system including a plurality of devices connected together by means of a network, the devices having respective data storage sites in which a user may store data, wherein the site where data is stored in the system is selected as a function of information associated with the user of the system.

2. The method according to claim 1, wherein the information is information associated with the user's activity relative to a device.

3. The management method according to claim 1, wherein the information corresponds to a defined state relative to an interpersonal communications tool, and in that a state corresponds to a predefined storage location.

4. The management method according to claim 1, wherein selection is followed by transferring data form a source storage site to a destination storage site, and in that after the transfer, the data stored in the source site is erased.

5. The management method according to claim 1, wherein the system comprises a module suitable for managing the data storage site in the distributed storage system, and after data has been transferred from a source storage site to a designation storage site, the data stored in the source device is conserved, and in that if a transfer from the designation storage site to the source device relates to the same data, then said transfer comprises a step of updating the new storage site.

6. A distributed storage system comprising a plurality of devices, each having respective storage means in which a user can store data, the devices being connected to one another via a network, wherein the system comprises a module suitable for selecting a data storage site within the system as a function of information associated with the user of the system.

7. A module suitable for managing the site where data is stored in a distributed storage system comprising a plurality of devices connected to one another via a network, the devices comprising respective data storage sites in which a user can store data, wherein the module includes selector means suitable for selecting a data storage site within the system as a function of information associated with the user of the system.

8. A non-transitory computer program product comprising instructions for implementing the method according to claim 1 in a module when the program is executed by a processor.
